(19) United States
(12) Patent Application Publication
(10) Pub. No.: US 2025/0201987 A1
(43) Pub. Date: Jun. 19, 2025

(54) ELECTRICITY STORAGE DEVICE

(71) Applicant: Panasonic Intellectual Property Management Co., Ltd., Osaka (JP)

(72) Inventors: Shunya IGARASHI, Osaka Fu (JP); Toshitaka KOBAYASHI, Osaka Fu (JP); Hiroki HAYASHI, Kyoto Fu (JP); Hideki SHIMAMOTO, Kyoto Fu (JP)

(73) Assignee: Panasonic Intellectual Property Management Co., Ltd., Osaka (JP)

(21) Appl. No.: 18/849,157

(22) PCT Filed: Mar. 20, 2023
(86) PCT No.: PCT/JP2023/011000

§ 371 Date: Sep. 20, 2024

(30) Foreign Application Priority Data
Mar. 23, 2022 (JP) 2022-047483

(51) Int. Cl. H01M 50/186; H01M 10/0587; H01M 50/107; H01M 50/184; H01M 50/193; H01M 50/533

(52) U.S. Cl. CPC H01M 50/186; H01M 10/0587; H01M 50/107; H01M 50/184; H01M 50/193; H01M 50/533

(57) ABSTRACT

A power storage device includes a case having a bottomed tubular shape, a wound element housed in the case, and having an end face at which a current collector is exposed, a current collecting plate joined to the end face of the wound element, and a sealing rubber housed at an opening of the case, and sealing the case by being pressed via a side surface portion of the case. One or more protrusions protruding toward the current collecting plate are provided on a facing surface of the sealing rubber facing the current collecting plate. At least one of the protrusions is in contact with the current collecting plate.

### TECHNICAL FIELD

The present disclosure relates to a power storage device.

### BACKGROUND ART

With expanding demand for in-vehicle applications, etc., power storage devices represented by secondary batteries have been required to have higher output and higher capacity. As a current collecting structure for obtaining high output, studies have been made to a so-called end-face current collecting structure in which a negative or positive electrode current collector-exposed portion is protruded from an end face of a wound electrode group, and welded to a current collecting plate.

Patent Literature 1 discloses a power storage device including: a power storage element having a first electrode, and a second electrode, and having a first end portion from which the first electrode is drawn out: an electrolyte impregnated in the power storage element: a terminal plate having an element connection portion electrically connected to the first electrode at the first end portion, and an external terminal portion connected to the element connection portion: an outer body having a tubular shape with an opening, and housing the power storage element, together with a liquid electrolyte; and a sealing member having an insertion hole through which the external terminal portion is inserted, and sealing the opening of the outer body, together with the external terminal portion. The external terminal portion is a columnar or tubular body having a tapered portion in the outer periphery at the tip. In the direction extending from the bottom surface of the outer body to the opening, the end side of the side wall at the opening of the outer body is positioned between both ends of the tapered portion.

### CITATION LIST

### Patent Literature

Patent Literature 1: Domestic re-publication of PCT international application No. 2013-088724

### SUMMARY OF INVENTION

### Technical Problem

The power storage device disclosed in Patent Literature 1 is fabricated by inserting and stacking the power storage element, the terminal plate, and the sealing member in the bottomed tubular outer body (battery can), and crimping the open end of the battery can onto the sealing member. In this case, the component tolerances and the assembly tolerance of the power storage element, the terminal plate, and the sealing member will add up in the axial direction of the battery can, to increase the positional variations in the axial direction of the sealing member. As a result, the adhesion between the crimped portion of the battery can and the sealing member is weakened, causing a decrease in sealing strength in some cases.

### Solution to Problem

One aspect of the present disclosure relates to a power storage device, including: a case having a bottomed tubular shape; a wound element housed in the case, and having an end face at which a current collector is exposed; a current collecting plate joined to the end face of the wound element; and a sealing rubber housed at an opening of the case, and sealing the case by being pressed via a side surface portion of the case, wherein one or more protrusions protruding toward the current collecting plate are provided on a facing surface of the sealing rubber facing the current collecting plate, and at least one of the protrusions is in contact with the current collecting plate.

While the novel features of the invention are set forth particularly in the appended claims, the invention, both as to organization and content, will be better understood and appreciated, along with other objects and features thereof, from the following detailed description taken in conjunction with the drawings.

### Advantageous Effects of Invention

The adhesion between the case and the sealing member can be maintained high, and the decrease in sealing strength can be suppressed.

### BRIEF DESCRIPTION OF DRAWINGS

FIG. 1 A longitudinal cross-sectional view showing the configuration of a power storage device according to an embodiment of the present disclosure.

FIG. 2 A side view and a top view of a sealing rubber in a load-free state used in a power storage device according to an embodiment of the present disclosure.

FIG. 3 Diagrams showing examples of the arrangement of protrusions disposed on the surface of a sealing rubber facing a current collecting plate.

FIG. 4 Diagrams showing examples of the arrangement of protrusions disposed on the surface of the sealing rubber facing the current collecting plate.

FIG. 5 Diagrams showing examples of the arrangement of protrusions disposed on the surface of the sealing rubber facing the current collecting plate.

FIG. 6 Diagrams showing examples of the protruding shape of protrusions of the sealing rubber.

FIG. 7 Diagrams showing an example of the protruding shape of protrusions of the sealing rubber.

### DESCRIPTION OF EMBODIMENTS

Embodiments of the present disclosure will be described below. In the description below, embodiments of the present disclosure will be described by way of examples, but the present disclosure is not limited to the below-described examples. In the following description, specific numerical values and materials are exemplified in some cases, but other numerical values and other materials may be adopted as long as the effects of the present disclosure can be obtained. In the present specification, the phase “a numerical value A to a numerical value B” includes the numerical value A and the numerical value B, and can be rephrased as “a numerical value A or more and a numerical value B or less.” In the following description, when the lower and upper limits of numerical values related to specific physical properties, conditions, etc. are mentioned as examples, any one of the mentioned lower limits and any one of the mentioned upper limits can be combined in any combination as long as the lower limit is not equal to or more than the upper limit. When a plurality of materials are mentioned as examples, one kind of them may be selected and used singly, or two or more kinds of them may be used in combination.

The present disclosure encompasses a combination of matters recited in any two or more claims selected from plural claims in the appended claims. In other words, as long as no technical contradiction arises, matters recited in any two or more claims selected from plural claims in the appended claims can be combined.

A power storage device according to one embodiment of the present disclosure includes: a case having a bottomed tubular shape; a wound element housed in the case, and having an end face at which a current collector is exposed; a current collecting plate joined to the end face of the wound element; and a sealing rubber housed at an opening of the case, and sealing the case by being pressed via a side surface portion of the case. One or more protrusions protruding toward the current collecting plate are provided on a facing surface of the sealing rubber facing the current collecting plate. At least one of the protrusions is in contact with the current collecting plate.

The power storage device is fabricated by housing the wound element, the current collecting plate, and the sealing rubber within the case in a stacked state in this order, and then crimping the open end of the case onto the sealing rubber, to seal the opening of the case. In this case, the fabrication process of the power storage device can be simplified, but on the other hand, the tolerances of the respective components and the assembly tolerance of the wound element, the current collecting plate, and the sealing rubber will add up in the axial direction of the case (the direction in which the tube portion of the tubular case extends), tending to increase the positional variations in the axial direction of the sealing rubber.

The protrusions provided on the sealing rubber undergo compression and/or deformation as appropriate when coming in contact with the current collecting plate, and serve to absorb or offset the component tolerances and the assembly tolerance that occur during device fabrication. This can bring the sealing rubber into close contact with the case, so that high sealing strength can be stably obtained.

Due to the component tolerances and the assembly tolerance of the wound element and the current collecting plate, variations are caused in the height of the current collecting plate relative to the bottom of the case. Depending on this variations, the height of the sealing rubber relative to the bottom of the case can also vary. When the case opening is sealed while there are variations in the height of the sealing rubber, for example, the length of the curled portion of the open end of the case to be crimped onto the sealing rubber may vary, causing variations in the adhesion between the sealing rubber and the case, depending on the height of the sealing rubber.

However, in the power storage device according to the present embodiment, since the sealing rubber is provided with a protrusion(s), the open end of the case can be crimped onto the sealing rubber with the sealing rubber positioned at a certain height relative to the bottom of the case, and sealing can be performed while the curled portion has a certain length, so that the sealing strength can be stably maintained high. For example, in assembling, when the height of the current collecting plate relative to the bottom of the case is high due to the component tolerances and the assembly tolerance, the amount of deformation or compression of the protrusion(s) increases, and when low, the amount of deformation or compression of the protrusion(s) decreases. In other words, the protrusion(s) is deformed and/or compressed depending on the tolerances, which makes it easy to implement the sealing while the height of the sealing rubber is kept constant.

A plurality of protrusions may be provided on the facing surface of the sealing rubber facing the current collecting plate. The plurality of protrusions may be arranged at intervals along the circumferential direction of the current collecting plate. The plurality of protrusions may be arranged at intervals along the circumferential direction at equiangular positions with respect to the center position of the sealing rubber, or may not necessarily be equiangular.

The cross-sectional shape of each of the protrusions in a plane perpendicular to its protruding direction is not particularly limited, and may be a circle, and may be a square or a regular polygon. The cross-sectional shape may be a shape, such as a rectangle, whose width in a specific first direction is larger (having a large aspect ratio) than its width in a second direction intersecting the first direction. The protruding direction is usually a direction perpendicular to the facing surface and parallel to the direction in which the tube portion of the case extends.

The cross-sectional shape may be a circular arc or an arc shape. In this case, the circular arc or the arc shape preferably extends along the circumferential direction of the current collecting plate.

A slit (groove) may be provided on the contacting surface of each of the protrusions with the current collecting plate. In this case, each of the parts of the protrusion divided by the slit is easily deformed when the protrusion comes in contact with the current collector and is subjected to pressure, and the effect of absorbing the component tolerances and the assembly tolerance is enhanced. The slit may have a cross shape.

The protrusions may each have a side surface perpendicular to its protruding direction. The protrusion having a side surface perpendicular to the protruding direction can be columnar. However, without limited thereto, the protrusions may each have a side surface inclined in its protruding direction. The side surface is inclined such that the cross-sectional area in a plane perpendicular to the protruding direction becomes smaller toward the tip of the protrusion (i.e., such that the tip becomes sharp). The protrusions may each have a plurality of side surfaces with different inclination angles formed with respect to the protruding direction. In this case, it becomes easy to control the direction in which the protrusions deform.

For example, the inclination angle can be made different within the protrusion, such that the inclination angle of the side surface of the protrusion with respect to the protruding direction is larger on the side closer to the central axis of the sealing rubber than on the side farther from the central axis. In this case, when the protrusions come in contact with the current collector and are subjected to pressure, the protrusions are each likely to deform so as to collapse radially outward in the direction away from the central axis. By this, the sealing rubber is suppressed from tilting relative to the current collecting plate following the deformation of the protrusions.

At least one of the protrusions preferably applies pressure to the current collecting plate. However, in order to prevent a deformation, such as buckling, from occurring in the wound element by the pressure application, the protrusions are configured to deform under a stress lower than a stress at which buckling occurs in the wound element, when subjected to stress due to pressure application. The stress which the protrusions are subjected to can be adjusted by the protruding height of the protrusions, the shape and the area of the cross section in a plane perpendicular to the protruding direction, the number of the protrusions, and the like. For example, in the case of a cylindrical device of 18715 type having diameter of 18.0 mm and a height of 71.5 mm, in which the sealing rubber is butyl rubber (Young's modulus at room temperature is 10 to 20 MPa), the protruding height of the protrusions, the cross-sectional shape and the cross-sectional area, the number of the protrusions, and the like can be adjusted so that the repulsive force generated by the deformation of the protrusions falls within the range of 50 N to 240 N.

The protruding height of the protrusions is, for example, in the range of 0.5 mm to 2.0 mm. When the cross-sectional shape is a circle, the size of the protrusions is, for example, in the range of 1.0 mm to 2.0 mm in diameter. Such protrusions also suit the above-mentioned 18715 type cylindrical device.

When a plurality of protrusions are provided, the protruding heights thereof may be made different among the protrusions.

The sealing rubber may have a countersunk portion (recess) provided on the facing surface, and the protrusions may be disposed in the countersunk portion. In this case, the height of the protrusions can be set high, allowing the protrusions to be easily deformed. This, as a result, enhances the effect of absorbing the component tolerances and the assembly tolerances. The depth of the countersunk portion relative to the facing surface is, for example, 0.1 mm to 1.5 mm.

In the present disclosure, the power storage device encompasses batteries, such as lithium-ion secondary batteries and lithium primary batteries, and capacitors, such as lithium-ion capacitors and electric double layer capacitors. Each of the positive and negative electrodes of the power storage device may be a polarized electrode, and may be a non-polarized electrode. The power storage device according to an embodiment of the present disclosure can be adopted in any power storage device structure, regardless of whether it is a primary battery or a secondary battery, and regardless of what configuration the positive electrode and the negative electrode have. The power storage device is suitable to be configured as, for example, a nonaqueous electrolyte secondary battery, an alkaline storage battery, or a capacitor, and contributes to achieving high output of nonaqueous electrolyte batteries. Nonaqueous electrolyte batteries include lithium-ion secondary batteries, all-solid-state batteries, and the like.

In the following, a power storage device according to an embodiment of the present disclosure will be specifically described with reference to the drawings, with a lithium-ion secondary battery taken as an example.

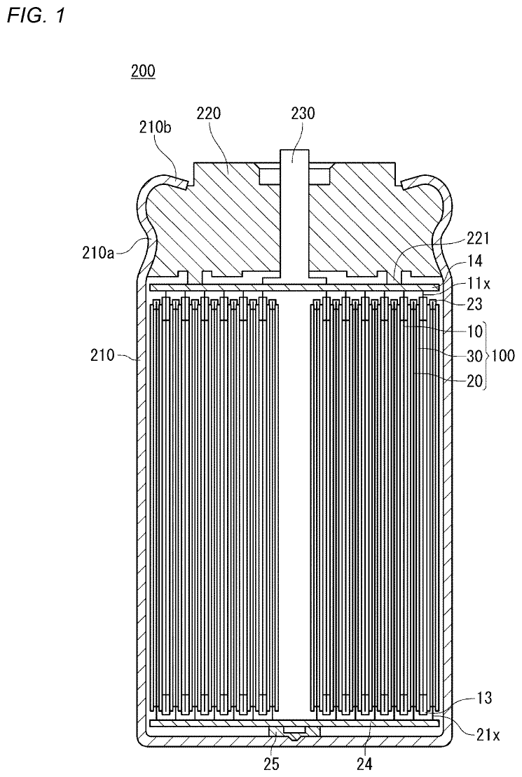

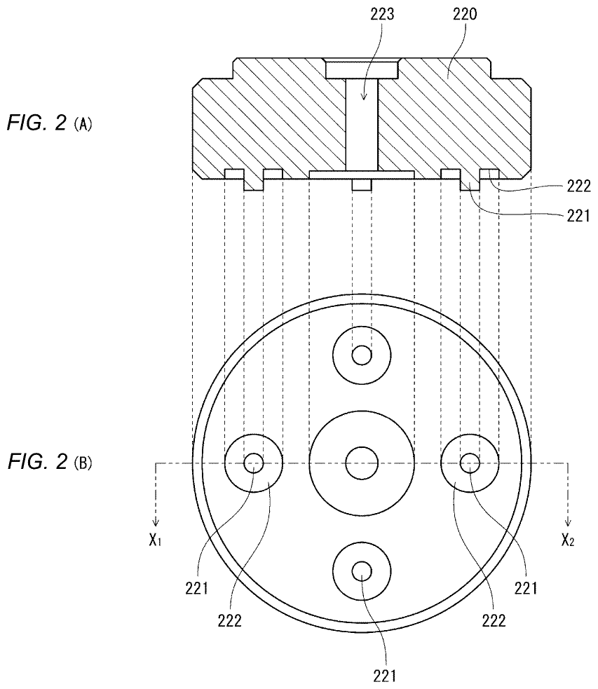

FIG. 1 is a longitudinal cross-sectional view showing the configuration of a battery 200 according to the present embodiment. FIG. 2 is a cross-sectional view and a top view of a sealing rubber 220 in a load-free state used in the battery 200. FIG. 2(A) is a cross-sectional view taken along the line X₁-X₂ in FIG. 2(B), and FIG. 2(B) is a top view of the sealing rubber 220 as seen from the side facing a current collecting plate 14.

The battery 200 includes a wound element 100 formed into a columnar shape by winding a positive electrode 10 and a negative electrode 20, with a separator 30 interposed therebetween, a nonaqueous electrolyte (not shown), a metal case 210 with a bottom housing the wound element 100 and the nonaqueous electrolyte, the sealing rubber 220 sealing the opening of the case 210, the current collecting plate 14, and a terminal 230.

The sealing rubber 220 has a through-hole 223 in the center, and the terminal 230 is inserted through the through-hole 223. One end of the terminal 230 is electrically connected to the current collecting plate (positive electrode current collecting plate) 14. The other end of the terminal 230 is exposed outside the battery 200, and functions as an external terminal of the battery 200 (in the example of FIG. 1, an external positive electrode terminal).

The sealing rubber 220 is pressed via a side surface portion (tube portion) 210a of the case 210, and the open end of the case 210 is crimped onto the sealing rubber 220, sealing the inside of the case 210. By the crimping, a curled portion 210b is formed at the open end of the case 210.

Protrusions 221 protruding toward the current collecting plate 14 are disposed on the facing surface of the sealing rubber facing the current collecting plate 14. The protrusions 221 come in contact with the current collecting plate 14, or may come in contact under pressure, with the current collecting plate 14. The protrusions 221 may come in contact, in a compressed or deformed state by pressure application, with the current collecting plate 14.

In the example shown in FIG. 2(B), four protrusions 221 are arranged at equiangular positions in the circumferential direction. The present invention, however, is not limited to the number of protrusions. The protrusions 221 may be arranged in plurality, or may be singly. The one or plurality of protrusions 221 can be arranged at a position that does not interfere with an electrolyte injection port provided in the current collecting plate 14.

The greater the number of the protrusions 221 provided on the facing surface, when the sealing rubber is inserted into the case, the less likely the sealing rubber is to be inserted in a slanted state with respect to the bottom of the case, so that the sealing rubber can be positioned horizontally within the case, and the assembling stability can be improved.

In the examples shown in FIGS. 1 and 2, the protrusions 221 are disposed in a countersunk portion (recess) 222 provided on the facing surface of the sealing rubber facing the current collecting plate 14. By this, the protruding height of the protrusions 221 is set higher, making the protrusions to be more likely subjected to compression or deformation under pressure. The present invention, however, is not limited thereto, and the protrusions 221 may be disposed in a flat region of the facing surface, as shown in the examples below.

The nonaqueous electrolyte has lithium-ion conductivity, and contains a lithium salt and a nonaqueous solvent that dissolves the lithium salt.

The positive electrode 10 is in the form of a long sheet, and includes a positive electrode current collector and a positive electrode active material layer supported thereon. The positive electrode active material layer is formed on both sides of the positive electrode current collector. However, a positive electrode current collector-exposed portion 11x without the positive electrode active material layer may be formed at one end along the longitudinal direction of the positive electrode current collector. The positive electrode current collector-exposed portion 11x is exposed at one end face of the wound element 100, and via the positive electrode current collector-exposed portion 11x, the positive electrode is electrically connected to the current collecting plate 14. The positive electrode current collector-exposed portion 11x is connected to the current collecting plate 14 by, for example, welding. On the other hand, the other end along the longitudinal direction of the positive electrode current collector is covered with an insulating layer 13.

The negative electrode 20 is in the form of a long sheet, and includes a negative electrode current collector and a negative electrode active material layer supported thereon. The negative electrode active material layer is formed on both sides of the negative electrode current collector. However, a negative electrode current collector-exposed portion 21x without the negative electrode active material layer is formed at one end (the end opposite to the positive electrode current collector-exposed portion 11x) along the longitudinal direction of the negative electrode current collector. The negative electrode current collector-exposed portion 21x is exposed on the other end face of the wound element 100, and via the negative electrode current collector-exposed portion 21x, the negative electrode is electrically connected to a current collecting plate (negative electrode current collecting plate) 24. The negative electrode current collector-exposed portion 21x is connected to the current collecting plate 24 by, for example, welding. The other end along the longitudinal direction of the negative electrode current collector is covered with an insulating layer 23. The current collecting plate 24 is welded to a welding member 25 provided on the inner bottom surface of the case 210. Thus, the case 210 functions as an external negative electrode terminal.

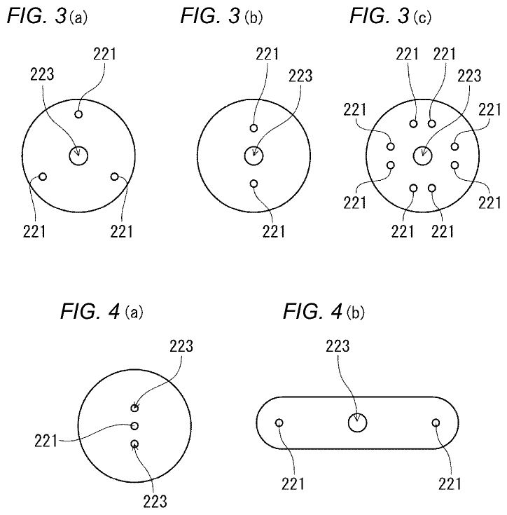

In FIGS. 3 to 5, other examples of the arrangement of the protrusions 221 disposed on the facing surface of the sealing rubber facing the current collecting plate 14 are shown. The illustrations in FIGS. 3 to 5 are each a top view of the sealing rubber as seen from the side facing the current collecting plate 14.

FIG. 3(a) is an example in which three protrusions 221 are arranged at equiangular positions in the circumferential direction. FIG. 3(b) is an example in which two protrusions 221 are arranged at equiangular positions in the circumferential direction (i.e., so as to face each other across the through-hole 223 located at the center of the sealing rubber). FIG. 3(c) is an example in which eight protrusions 221 are arranged on the facing surface. The eight protrusions 221 can be arranged symmetrically while avoiding an electrolyte injection port provided in the current collecting plate 14.

The protrusions 221 may be provided singly on the facing surface. FIG. 4(a) is an example in which one protrusion 221 is disposed at the center position of the sealing rubber. In this example, two through-holes 223 are disposed at positions facing each other across the protrusion 221.

FIG. 4(b) is an example showing the configuration of a sealing rubber when the present invention is applied to an elliptical or track-shaped tubular device. Two protrusions 221 are respectively disposed on both ends in the longitudinal direction of the sealing rubber having a track-shaped cross section.

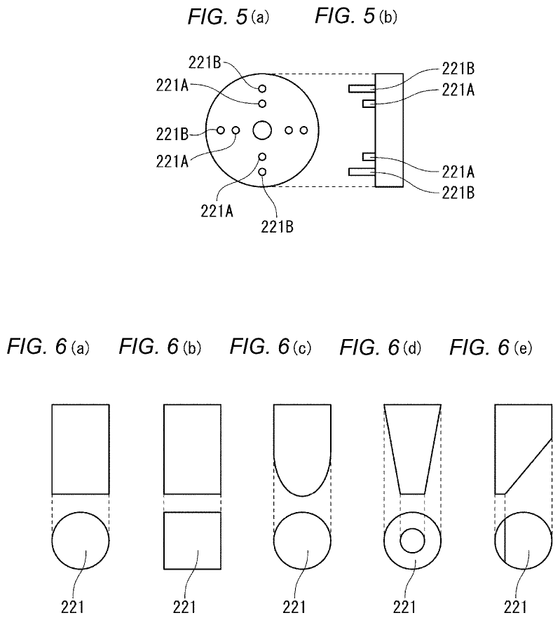

FIG. 5 is an example of another configuration of the sealing rubber, with a top view of the sealing rubber as seen from the facing surface shown in FIG. 5(a), and a side view of the sealing rubber shown in FIG. 5(b). In this example, eight protrusions 221 are arranged on the facing surface. The eight protrusions 221 consist of four protrusions 221A arranged at equiangular positions in the circumferential direction, and four protrusions 221B arranged radially more outward than the protrusions 221A at equiangular positions in the circumferential direction. The protruding height of the protrusions 221B is higher than the protruding height of the protrusions 221A.

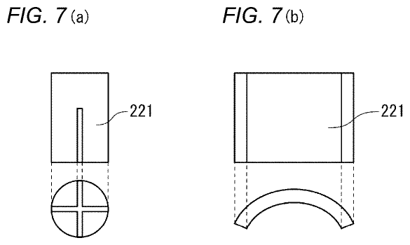

In FIGS. 6 and 7, examples of the protruding shape of the protrusion 221 are shown. In each of the examples in FIGS. 6(a) to (e) and FIGS. 7(a) and (b), the upper illustration shows a side view of the protrusion as seen from a direction perpendicular to the protruding direction, and the lower illustration shows a top view as seen from the protruding surface (the surface facing the current collecting plate).

As shown in FIGS. 6(a) and (b), the protrusion 221 may be a cylinder or a prism. The protrusion 221 has a side surface perpendicular to the protruding direction. In these cases, the protrusion 221 has a simple shape, and is easy to process.

As shown in FIGS. 6(c) and (d), in the protrusion 221, a side surface perpendicular to the protruding direction may be inclined. The inclined side surface can form the tip of the protrusion 221 to be sharp. The inclined side surface may be a curved surface, may be formed of one or more flat surfaces, or may include a combination of these. FIG. 6(c) is an example of the tip of the protrusion 221 formed of a curved surface, in which the tip of the protrusion 221 is formed of a spherical surface or an ellipsoidal surface. FIG. 6(d) is an example in which the tip of the protrusion 221 is formed in the shape of a truncated cone. In these cases, the protrusion 221 is easy to process, and deforms easily.

FIG. 6(e) is an example in which the protrusion 221 has a plurality of side surfaces with different inclination angles relative to the protruding direction. In the example shown in FIG. 6(e), the tip of the protrusion 221 is provided with a cutout, forming an inclined side surface. In this case, the protrusion 221 is easy to process, and deforms more easily, and especially is likely to undergo deformation so as to collapse toward the side opposite to the surface on which the cutout is provided.

In FIG. 7(a), a slit is provided at the tip of the protrusion 221. The tip portion of the protrusion 221 is divided into a plurality of parts by the slit. Each of the parts divided by the slit can deform independently, so that the protrusion 221 deforms easily. Note that in the example of FIG. 7(a), the shape of the slit is a cross shape, but is not limited thereto.

FIG. 7(b) is an example in which the cross-sectional shape in a plane perpendicular to the protruding direction of the protrusion 221 is a circular arc shape. Although the circular arc-shaped protrusion 221 has a higher rigidity and does not easily deform as compared with the examples shown in FIGS. 6(a) to (e) and FIG. 7(a), the protrusion 221 shown in FIG. 7(b) can be used depending on the device structure.

### (Sealing Rubber)

By using a rubber material as the sealing member, a stable sealing repulsive force is obtained, leading to improved sealing performance of the power storage device. In addition, since the protrusions are made of a rubber material, the protrusions can deform when coming in contact with the current collector and subjected to pressure, and can absorb the component tolerances and the assembly tolerance. The sealing rubber having a protrusion(s) is manufactured by, for example, a molding technique, such as compression molding.

A rubber material, on the other hand, deforms easily with an increase in the internal pressure, and becomes not rigid enough for suppressing bulging, in some cases. In order to improve the rigidity of the sealing rubber and achieve both high sealing repulsive force and suppression of bulging, the sealing rubber may have a laminated structure having at least two layers of a rubber material layer (e.g., a butyl rubber layer) and a fluorocarbon resin layer. In this case, the protrusions are provided on the rubber material layer.

Although depending on the ambient temperature, the Young's modulus of the rubber material layer may be in the range of 4 MPa to 80 MPa. In contrast, the Young's modulus of the fluorocarbon resin may be 0.4 GPa or more as a general value.

The sealing rubber may be constituted of a single layer of a rubber material layer containing a rubber material, or may have a multilayer structure of a rubber material layer and a fluorocarbon resin layer. Preferred as the rubber material is butyl rubber (isobutylene-isoprene copolymer) (IIR). Butyl rubber exhibits stable elasticity through peroxide crosslinking or resin crosslinking, and a stable sealing repulsive force can be stably obtained.

Butyl rubber, as compared to other rubber materials, has low gas permeability and high insulating properties, enabling to maintain the performance of the power storage device high even during a long-term storage.

Preferred example of the material of the fluorocarbon resin layer are PTFE (polytetrafluoroethylene), PVDF (polyvinylidene fluoride), PFA (perfluoroalkoxyalkane), ETFE (ethylene-tetrafluoroethylene copolymer), and FEP (perfluoroethylene-propene copolymer). In forming a multilayer structure of a butyl rubber layer and a fluorocarbon resin layer, in order to improve the adhesion at the interface with the rubber material layer, it is preferable to roughen the surface of the fluorocarbon resin layer on the side facing the butyl rubber layer by means of, for example, corona treatment, plasma treatment, sodium treatment, or application of an organic solvent including active sodium dissolved therein, and perform compression molding in a state in which the adhesion with the butyl rubber layer has been improved.

### (Current Collecting Plate)

The material constituting the current collecting plate is determined according to the material constituting the positive electrode and the negative electrode. For example, when used as a negative electrode current collecting plate of a lithium-ion secondary battery, the material of the current collecting plate is, for example, copper, copper alloy, nickel, stainless steel, etc. The material of the negative electrode current collecting plate may be the same as the material of the negative electrode current collector. For example, when used as a positive electrode current collecting plate of a lithium-ion secondary battery, the material of the current collecting plate is, for example, aluminum, aluminum alloy, titanium, stainless steel, etc. The material of the positive electrode current collecting plate may be the same as the material of the positive electrode current collector.

The current collector-exposed portion and the current collecting plate can be joined by, for example, laser welding. The laser may be irradiated radially at multiple points from, for example, the side opposite to the surface of the current collecting plate facing the end face of the wound element (i.e., the side facing the sealing rubber).

### (Positive Electrode)

For the positive electrode current collector, a sheet of metal material is used. The sheet of metal material may be a metal foil, a metal porous body, an etched metal, and the like. The metal material may be aluminum, aluminum alloy, nickel, titanium, and the like. The thickness of the positive electrode current collector is, for example, 10 μm to 100 μm.

The positive electrode active material layer includes, for example, a positive electrode active material, a conductive material, and a binder. The positive electrode active material layer is obtained by, for example, applying a positive electrode mixture slurry including the positive electrode active material, the conductive material, and the binder, onto both sides of a positive electrode current collector, and drying the applied film, followed by rolling. The positive electrode active material is a material that absorbs and releases lithium ions. Examples of the positive electrode active material include a lithium-containing transition metal oxide, a transition metal fluoride, a polyanion, a fluorinated polyanion, and a transition metal sulfide.

When the power storage device is a capacitor, such as a lithium-ion capacitor or an electric double layer capacitor, the positive electrode active material layer may contain a positive electrode active material which is to be reversibly doped with anions. When anions are adsorbed onto the positive electrode active material, an electric double layer is formed, to exhibit capacity. The positive electrode may be a polarizable electrode, and may be an electrode which has the properties of a polarizable electrode and in which the Faraday reaction also contributes to its capacity. The positive electrode active material is, for example, a carbon material, a conductive polymer, and the like.

The conductive polymer is preferably a n-conjugated polymer. As the x-conjugated polymer, for example, polypyrrole, polythiophene, polyfuran, polyaniline, polythiophene vinylene, polypyridine, or a derivative thereof can be used. These may be used singly or in combination of two or more. The weight average molecular weight of the conductive polymer is, for example, 1000 to 100,000. The derivative of a x-conjugated polymer means a polymer whose basic backbone is a x-conjugated polymer, such as polypyrrole, polythiophene, polyfuran, polyaniline, polythiophene vinylene, and polypyridine. For example, a polythiophene derivative includes poly(3,4-ethylenedioxythiophene) (PEDOT).

The carbon material is preferably a porous carbon material, preferable examples of which include an activated carbon and the carbon materials exemplified as the negative electrode active material (e.g., non-graphitizable carbon). Examples of the raw material of the activated carbon include wood, coconut shell, coal, pitch, and phenolic resin. The activated carbon is preferably one that has been subjected to an activation treatment.

### (Negative Electrode)

For the negative electrode current collector, a sheet of metal material is used. The sheet of metal material may be a metal foil, a metal porous body, an etched metal, and the like. The metal material may be copper, copper alloy, nickel, stainless steel, and the like. The thickness of the negative electrode current collector is, for example, 10 μm to 100 μm.

The negative electrode active material layer includes, for example, a negative electrode active material, a conductive material, and a binder. The negative electrode active material layer is obtained by, for example, applying a negative electrode mixture slurry including a negative electrode active material, a conductive material, and a binder, onto both sides of a negative electrode current collector, and drying the applied film, followed by rolling. The negative electrode active material is a material that absorbs and releases lithium ions. Examples of the negative electrode active material include a carbon material, a metal compound, an alloy, and a ceramics material. Examples of the carbon material include graphite and hard carbon.

### (Separator)

The separator may be, for example, a microporous film made of a resin such as polyolefin, a woven fabric, a nonwoven fabric, and the like. The thickness of the separator is, for example, 10 to 300 μm, and preferably 10 to 40 μm.

### (Nonaqueous Electrolyte)

The nonaqueous electrolyte has lithium-ion conductivity and contains a lithium salt and a nonaqueous solvent that dissolves the lithium salt.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

### INDUSTRIAL APPLICABILITY

The current collecting plate according to the present disclosure can be used to realize a high-output power storage device, and is therefore suitable, for example, for in-vehicle use.

### REFERENCE SIGNS LIST

100: wound element
   10: positive electrode
      11x: positive electrode current collector-exposed portion
      13: insulating layer
   14: current collecting plate (positive electrode current collecting plate)
   20: negative electrode
      21x: negative electrode current collector-exposed portion
      23: insulating layer
   24: current collecting plate (negative electrode current collecting plate)
   30: separator
200: battery (power storage device)
   210: case
      210a: side surface portion
      210b: curled portion
   220: sealing rubber
      221, 221A, 221B: protrusion
      222: countersunk portion (recess)
      223: through-hole
   230: terminal

1. A power storage device, comprising:
a case having a bottomed tubular shape;
a wound element housed in the case, and having an end face at which a current collector is exposed;
a current collecting plate joined to the end face of the wound element; and
a sealing rubber housed at an opening of the case, and sealing the case by being pressed via a side surface portion of the case, wherein
one or more protrusions protruding toward the current collecting plate are provided on a facing surface of the sealing rubber facing the current collecting plate, and
at least one of the protrusions is in contact with the current collecting plate.

2. The power storage device according to claim 1, having a plurality of the protrusions on the facing surface.

3. The power storage device according to claim 1, wherein a cross-sectional shape of each of the protrusions in a plane perpendicular to a protruding direction thereof is an arc shape.

4. The power storage device according to claim 1, wherein a slit is provided on a contacting surface of each of the protrusions with the current collecting plate.

5. The power storage device according to claim 4, wherein the slit has a cross shape.

6. The power storage device according to claim 1, wherein the protrusions each has a side surface inclined with respect to a protruding direction such that a cross-sectional area in a plane perpendicular to the protruding direction decreases toward a tip of the protrusion.

7. The power storage device according to claim 6, wherein an inclination angle of the side surface of the protrusions with respect to the protruding direction is larger on a side closer to a central axis of the sealing rubber than on a side farther from the central axis.

8. The power storage device according to claim 1, wherein at least one of the protrusions applies pressure to the current collecting plate.

9. The power storage device according to claim 1, wherein the protrusions are configured to deform under a stress lower than a stress at which buckling occurs in the wound element.

10. The power storage device according to claim 1, wherein
the sealing rubber has a countersunk portion provided on the facing surface, and
the protrusions are disposed in the countersunk portion.
